(19) United States
(12) Patent Application Publication
(10) Pub. No.: US 2002/0165856 A1
(43) Pub. Date: Nov. 7, 2002

(54) Collaborative research systems

(76) Inventors: Lynne E. Gilfillan, Fairfax, VA (US); Theodore Yachik, Fairfax, VA (US)

Correspondence Address: ROPES & GRAY, ONE INTERNATIONAL PLACE, BOSTON, MA, 02110-2624, US

(21) Appl. No.: 10/096,236

(22) Filed: Mar. 12, 2002

Related U.S. Application Data
(60) Provisional application No. 60/288,456, filed on May 4, 2001.

(51) Int. Cl. G06F 7/00

(52) U.S. Cl. 707/3

(57) ABSTRACT

The systems described herein include collaborative research tools to assist with structuring and refining searches over a wide array of disparate data sources. The systems further permit variable access control to research results, for viewing and for editing, throughout iterative stages of research. Research may be conducted with varying degrees of collaboration over varying stages of research refinement, thus providing an end-to-end collaborative research tool that concludes with network publication of organized search results. The systems may be deployed in a number of architectures, including a client/server configuration or a stand-alone desktop application. The systems have broad application to research and knowledge management in interests ranging from academic to commercial, and may include medicine, engineering, law, history, economics, and more.

### CROSS-REFERENCE TO RELATED APPLICATIONS

This application claims the benefit of, and incorporates by reference, the entire disclosure of U.S. Provisional Patent Application No. 60/288,456 filed on May 4, 2001.

### GOVERNMENT INTERESTS

The United States Government has rights in this invention pursuant to Contract Nos. F30602-96-C-0184 and F30602-97-C-0080 awarded by the United States Air Force, and Contract No. N66001-99-D-8603 awarded by DARPA/NCI.

### FIELD OF THE INVENTION

The invention relates to knowledge management, and more particularly to collaborative research systems.

### BACKGROUND OF THE INVENTION

The information age is upon us. An increasingly wide array of data continually emerges from an increasingly disparate array of sources. At the same time, people are asking more complex questions, and joining together in geographically distributed teams to generate knowledge and answers.

Research tools are available to tackle various aspects of this problem. Search engine services such as AltaVista and Google endeavor to capture the content of the Internet in a Boolean-searchable index of terms. Further, a variety of database technologies and user-friendly database front-ends have been devised to more efficiently structure searches of large databases. As a significant disadvantage, none of these technologies provide a platform for sustaining research across available data sources among a number of parties, or over an extended period of time.

There remains a need for a persistent research tool that permits collaboration among researchers and sharing of research results.

### SUMMARY OF THE INVENTION

The systems described herein include collaborative research tools to assist with structuring and refining searches over a wide array of disparate data sources. The systems further permit variable access control to research results, for viewing and for editing, throughout iterative stages of research. Research may be conducted with varying degrees of collaboration over varying stages of research refinement, thus providing an end-to-end collaborative research tool that concludes with network publication of organized search results. The systems may be deployed in a number of architectures, including a client/server configuration or a stand-alone desktop application. The systems have broad application to research and knowledge management in interests ranging from academic to commercial, and may include medicine, engineering, law, history, economics, and more.

### BRIEF DESCRIPTION OF DRAWINGS

The foregoing and other objects and advantages of the invention will be appreciated more fully from the following further description thereof, with reference to the accompanying drawings, wherein:

FIG. 1 shows a schematic diagram of the entities involved in an embodiment of a method and system disclosed herein;

FIG. 2 shows a block diagram of a server that may be used with the systems described herein;

FIG. 3 shows a page that may be used as a user interface;

FIG. 4 shows an architecture that may be used with the systems described herein;

FIG. 5 is a flow chart of a search process using the systems described herein; and

FIG. 6 depicts a user interface that may be used with the systems described herein.

### DETAILED DESCRIPTION OF CERTAIN EMBODIMENTS

To provide an overall understanding of the invention, certain illustrative embodiments will now be described, including a client/server architecture for managing ongoing research through the Internet. However, it will be understood that the methods and systems described herein can be suitably adapted to any environment where data from a wide variety of sources is to be organized into a repository for shared access, and may be deployed, for example, within a corporate intranet or over a private network. Data sources may be limited to those available within a company or other organization, or otherwise constrained in a manner that enhances reliability. Further, access to shared research may be limited to a private group of users or shared publicly through the Internet. These and other applications of the systems described herein are intended to fall within the scope of the invention. More generally, the principles of the invention are generally applicable to any environment where ongoing research may benefit from structure, persistence, publication, and/or collaboration.

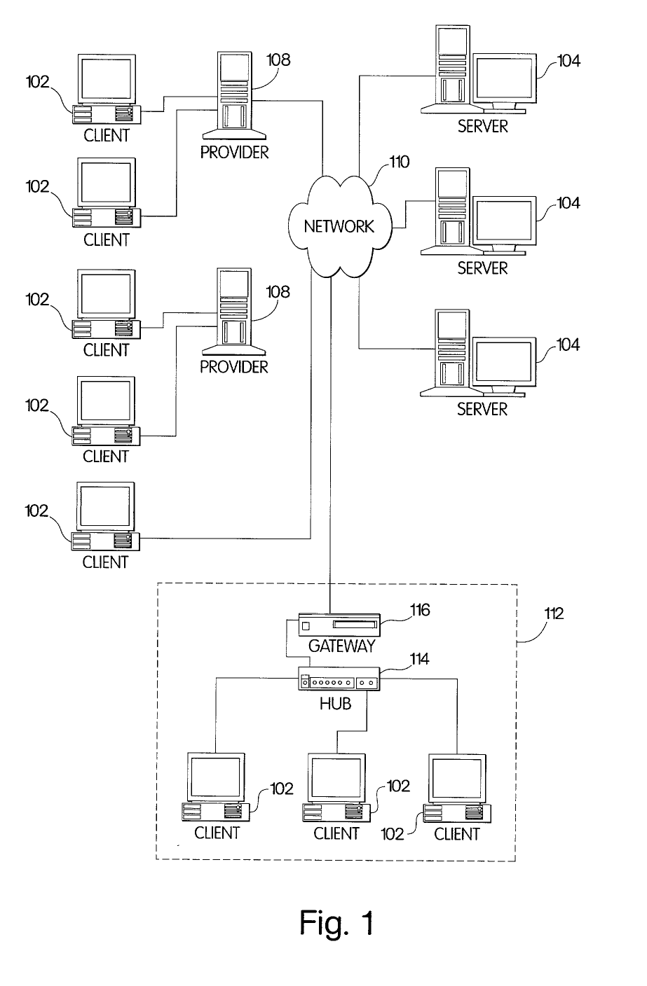

FIG. 1 shows a schematic diagram of the entities involved in an embodiment of a method and system disclosed herein. In a system 100, a plurality of clients 102, servers 104, and providers 108 are connected via an internetwork 110. It should be understood that any number of clients 102, servers 104, and providers 108 could participate in such a system 100. The system may further include one or more local area networks (“LAN”) 112 interconnecting clients 102 through a hub 114 (in, for example, a peer network) or a local area network server 114 (in, for example, a client-server network). The LAN 112 may be connected to the internetwork 110 through a gateway 116, which provides security to the LAN 112 and ensures operating compatibility between the LAN 112 and the internetwork 110. Any data network may be used as the internetwork 110 and the LAN 112.

In one embodiment, the internetwork 110 is the Internet, and the World Wide Web provides a system for interconnecting clients 102 and servers 104 through the Internet 110. The internetwork 110 may include a cable network, a wireless network, and any other networks for interconnecting clients, servers and other devices.

An exemplary client 102 includes the conventional components of a client system, such as a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as modem, digital subscriber line (“DSL”) card, cable modem, network interface card, wireless network card, or other interface device capable of wired, fiber optic, or wireless data communications. One example of such a client 102 is a personal computer equipped with an operating system such as Microsoft Windows 95, Microsoft Windows NT, Unix, Linux, and Linux variants, along with software support for Internet communication protocols. The personal computer may also include a browser program, such as Microsoft Internet Explorer or Netscape Navigator, to provide a user interface for access to the Internet 110. Although the personal computer is a typical client 102, the client 102 may also be a workstation, mobile computer, Web phone, television set-top box, interactive kiosk, personal digital assistant, or other device capable of communicating over the Internet 110. As used herein, the term “client” is intended to refer to any of the above-described clients 102, as well as proprietary network clients designed specifically for the collaborative research systems described herein, and the term “browser” is intended to refer to any of the above browser programs or other software or firmware providing a user interface for navigating the Internet 110 and/or communicating with the collaborative research systems.

An exemplary server 104 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic, and may include separate servers for different functions such as a database server, a file server, an application server, and a Web presentation server. Such servers may further include one or more mass storage devices such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Compaq, IBM, and Sun Microsystems. As used herein, the term “server” is intended to refer to any of the above-described servers 104.

Focusing now on the internetwork 110, one embodiment is the Internet. The structure of the Internet 110 is well known to those of ordinary skill in the art and includes a network backbone with networks branching from the backbone. These branches, in turn, have networks branching from them, and so on. The backbone and branches are connected by routers, bridges, switches, and other switching elements that operate to direct data through the internetwork 110. For a more detailed description of the structure and operation of the Internet 110, one may refer to “The Internet Complete Reference,” by Harley Hahn and Rick Stout, published by McGraw-Hill, 1994. However, one may practice the present invention on a wide variety of communication networks. For example, the internetwork 110 can include interactive television networks, telephone networks, wireless data transmission systems, two-way cable systems, customized computer networks, interactive kiosk networks and automatic teller machine networks. Further various data resources may be available through the internetwork 110, including text, images, multi-media, and databases that are provided through command line or graphical front-ends over the internetwork 110, and databases available through local networks connected to the internetwork 110. As will be described in more detail below, all of these data resources may be accessed by the systems described herein.

One embodiment of the internetwork 110 includes Internet service providers 108 offering dial-in service, such as Microsoft Network, America OnLine, Prodigy and CompuServe. It will be appreciated that the Internet service providers 108 may also include any computer system which can provide Internet access to a client 102. Of course, the Internet service providers 108 are optional, and in some cases, the clients 102 may have direct access to the Internet 110 through a dedicated DSL service, ISDN leased lines, T1 lines, digital satellite service, cable modem service, or any other high-speed connection. Any of these high-speed services may also be offered through one of the Internet service providers 108.

In its present deployment as the Internet, the internetwork 110 consists of a worldwide computer network that communicates using the well-defined Transmission Control Protocol (“TCP”) and Internet Protocol (“IP”) to provide transport and network services. Computer systems that are directly connected to the Internet 110 each have a unique IP address. The IP address consists of four one-byte numbers (although a planned expansion to sixteen bytes is underway with IPv6). The four bytes of the IP address are commonly written out separated by periods such as “194.152.65.222”. To simplify Internet addressing, the Domain Name System (“DNS”) was created. The DNS allows users to access Internet resources with a simpler alphanumeric naming system. A DNS name consists of a series of alphanumeric names separated by periods. For example, the name “www.lga-inc.com” corresponds to a particular IP address. When a domain name is used, the computer accesses a DNS server to obtain the explicit four-byte IP address.

It will be appreciated that other internetworks 110 may be used with the invention. For example, the internetwork 110 may be a wide-area network, a local area network, or corporate area network. The internetwork 110 may be any other network used to communicate data, such as a cable broadcast network.

To further define the resources on the Internet 110, the Uniform Resource Locator system was created. A Uniform Resource Locator (“URL”) is a descriptor that specifically defines a type of Internet resource along with its location. URLs have the following format:

resource-type://domain.address/path-name

where resource-type defines the type of Internet resource. Web documents are identified by the resource type “http” which indicates that the hypertext transfer protocol should be used to access the document. Other common resource types include “ftp” (file transmission protocol), “mailto” (send electronic mail), “file” (local file), and “telnet.” The domain.address defines the domain name address of the computer that the resource is located on. Finally, the path-name defines a directory path within the file system of the server that identifies the resource. As used herein, the term “IP address” is intended to refer to the four-byte Internet Protocol address, and the term “Web address” is intended to refer to a domain name address, along with any resource identifier and path name appropriate to identify a particular Web resource. The term “address,” when used alone, is intended to refer to either a Web address or an IP address.

In an exemplary embodiment, a browser, executing on one of the clients 102, retrieves a Web document at an address from one of the servers 104 via the internetwork 110, and displays the Web document on a viewing device, e.g., a screen. A user can retrieve and view the Web document by entering, or selecting a link to, a URL in the browser. The browser then sends an http request to the server 104 that has the Web document associated with the URL. The server 104 responds to the http request by sending the requested Web document to the client 102. The Web document is an HTTP object that includes plain text (ASCII) conforming to the HyperText Markup Language (“HTML”). Other markup languages are known and may be used on appropriately enabled browsers and servers, including the Dynamic HyperText Markup Language (“DHTML”), the Extensible Markup Language (“XML”), the Extensible Hypertext Markup Language (“XHML”), and the Standard Generalized Markup Language (“SGML”).

Each Web document usually contains hyperlinks to other Web documents. The browser displays the Web document on the screen for the user and the hyperlinks to other Web documents are emphasized in some fashion such that the user can identify and select each hyperlink. To enhance functionality, a server 104 may execute programs associated with Web documents using programming or scripting languages, such as Perl, C, C++, or Java. A server 104 may also use server-side scripting languages such as ColdFusion from Allaire, Inc., or PHP. These programs and languages perform “back-end” functions such as order processing, database management, and content searching. A Web document may also include references to small client-side applications, or applets, that are transferred from the server 104 to the client 102 along with a Web document and executed locally by the client 102. Java is one popular example of a programming language used for applets. The text within a Web document may further include (non-displayed) scripts that are executable by an appropriately enabled browser, using a scripting language such as JavaScript or Visual Basic Script. Browsers may further be enhanced with a variety of helper applications to interpret various media including still image formats such as JPEG and GIF, document formats such as PS and PDF, motion picture formats such as AVI and MPEG, and sound formats such as MP3 and MIDI. These media formats, along with a growing variety of proprietary media formats, may be used to enrich a user's interactive and audio-visual experience as each Web document is presented through the browser. The term “page” as used herein is intended to refer to the Web document described above, as well as any of the above-described functional or multimedia content associated with the Web document.

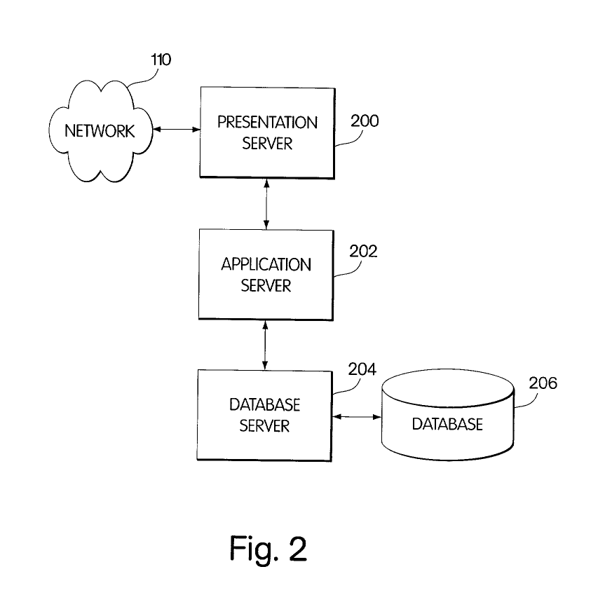

FIG. 2 shows a block diagram of a server that may be used with the systems described herein. In this embodiment, the server 104 includes a presentation server 200, an application server 202, and a database server 204. The application server 202 is connected to the presentation server 200. The database server 204 is also connected to the presentation server 200 and the application server 202, and is further connected to a database 206 embodied on a mass storage device. The presentation server 200 includes a connection to the internetwork 110. It will be appreciated that each of the servers may comprise more than one physical server, as required for capacity and redundancy, and it will be further appreciated that in some embodiments more than one of the above servers may be logical servers residing on the same physical device. It will further be appreciated that one or more of the servers may be at a remote location, and may communicate with the presentation server 200 through a local area or wide area network. The term “host,” as used herein, is intended to refer to any combination of servers described above that include a presentation server 200 for providing access to pages by the clients 102. The term “site,” as used herein, is intended to refer to a collection of pages sharing a common domain name address, or dynamically generated by a common host, or accessible through a common host (i.e., a particular page may be maintained on or generated by a remote server, but nonetheless be within a site).

The presentation server 200 provides an interface for one or more connections to the internetwork 110, thus permitting more than one of the clients 102 (FIG. 1) to access the site at the same time. In one embodiment, the presentation server 200 comprises a plurality of enterprise servers, such as the ProLiant Cluster available from Compaq Computer Corp., or a cluster of E250's from Sun MicroSystems running Solaris 2.7. Other suitable servers are known in the art and are described in Jamsa, Internet Programming, Jamsa Press (1995), the teachings of which are herein incorporated by reference. The server maintains one or more connections to the Internet 110, preferably provided by a tier one provider, i.e., one of the dozen or so national/international Internet backbones with cross-national links of T3 speeds or higher, such as MCI, UUNet, BBN Planet, and Digex. Each server may be, for example, an iPlanet Enterprise Server 4.0 from the Sun/Netscape Alliance. The presentation server 200 may also, for example, use the Microsoft Windows NT operating system, with a “front end” written in Microsoft Active Server Page (“ASP”), or some other programming language or server software capable of integrating ActiveX controls, forms, Visual Basic Scripts, JavaScript, Macromedia Flash Technology multimedia, e-mail, and other functional and multimedia aspects of a page. Typically, the front end includes all text, graphics, and interactive objects within a page, along with templates used for dynamic page creation.

A client 102 (FIG. 1) accessing an address hosted by the presentation server 200 will receive a page from the presentation server 200 containing text, forms, scripts, active objects, hyperlinks, etc., which may be collectively viewed using a browser. Each page may consist of static content, i.e., an HTML text file and associated objects (*.avi, *.jpg, *.gif, etc.) stored on the presentation server, and may include active content including applets, scripts, and objects such as check boxes, drop-down lists, and the like. A page may be dynamically created in response to a particular client 102 request, including appropriate queries to the database server 204 for particular types of data to be included in a responsive page. It will be appreciated that accessing a page is more complex in practice, and includes, for example, a DNS request from the client 102 to a DNS server, receipt of an IP address by the client 102, formation of a TCP connection with a port at the indicated IP address, transmission of a GET command to the presentation server 200, dynamic page generation (if required), transmission of an HTML object, fetching additional objects referenced by the HTML object, and so forth.

The application server 202 provides the “back-end” functionality of the Web site, and includes connections to the presentation server 200 and the database server 204. In one embodiment, the presentation server 200 comprises an enterprise server, such as one available from Compaq Computer Corp., running the Microsoft Windows NT operating system, or a cluster of E250's from Sun MicroSystems running Solaris 2.7. The back-end software may be implemented using pre-configured e-commerce software, such as that available from Pandesic, to provide back-end functionality including order processing, billing, inventory management, financial transactions, shipping instructions, and the like. The e-commerce software running on the application server 202 may include a software interface to the database server 204, as well as a software interface to the front end provided by the presentation server 200. The application server 200 may also use a Sun/Netscape Alliance Server 4.0. A payment transaction server may also be included to process payments at a Web site using third party services such as Datacash or WorldPay, or may process payments directly using payment server and banking software, along with a communication link to a bank. While the above describes one form of application server that may be used with the systems described herein, other configurations are possible, as will be described in further detail below.

The database server 204 may be an enterprise server, such as one available from Compaq Computer Corp., running the Microsoft Windows NT operating system or a cluster of E250's from Sun MicroSystems running Solaris 2.7, along with software components for database management. Suitable databases are provided by, for example, Oracle, Sybase, and Informix. The database server 204 may also include one or more databases 206, typically embodied in a mass-storage device. The databases 206 may include, for example, user interfaces, search results, search query structures, lexicons, user information, and the templates used by the presentation server to dynamically generate pages. In operation, the database management software running on the database server 204 receives properly formatted requests from the presentation server 200, or the application server 202. In response, the database management software reads data from, or writes data to, the databases 206, and generates responsive messages to the requesting server. The database server 204 may also include a File Transfer Protocol (“FTP”) server for providing downloadable files.

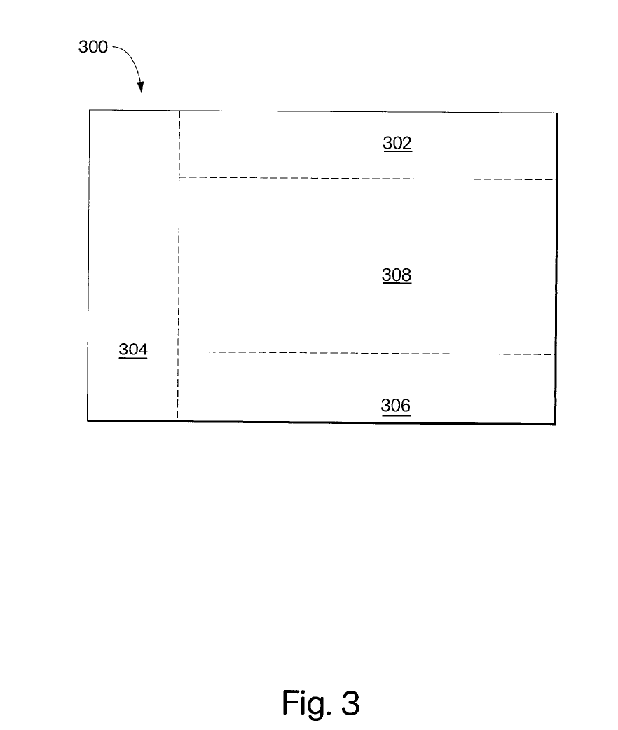

FIG. 3 shows a page that may be used as a user interface. The page 300 may include a header 302, a sidebar 304, a footer 306 and a main section 308, all of which may be displayed at a client 102 using a browser. The header 302 may include, for example, one or more banner advertisements and a title of the page. The sidebar 304 may include a menu of choices for a user at the client 102. The footer 306 may include another banner advertisement, as well as information concerning the page such as a “help” or “webmaster” contact, copyright information, disclaimers, a privacy statement, etc. The main section 308 may include content for viewing by the user. The main section 308 may also include, for example, tools for electronically mailing the page to an electronic mail (“e-mail”) account. It will be appreciated that the description above is generic, and may be varied according to where a client 102 is within a Web site related to the page, as well as according to any available information about the client 102 (such as display size, media capabilities, etc.) or the user (such as profile information).

A Web site including the page 300 may use cookies to track users and user information. In particular, a client 102 accessing the site may be accessed to detect whether the client 102 has previously accessed the page or the site. If the client 102 has accessed the site, then some predetermined content may be presented to the client 102. If the client 102 does not include a cookie indicating that the client 102 has visited the site, then the client 102 may be directed to a registration page where information may be gathered to create a user profile. The client 102 may also be presented with a login page, so that a pre-existing user on a new client 102 may nonetheless bypass the registration page.

The site may provide options to the client 102. For example, the site may provide a search tool by which the client 102 may search for content within the site, or content external to the site but accessible through the internetwork 110. The site may include news items topical to the site. Banner ads may be provided in the page 300, and the ads may be personalized to a client 102 if a profile exists for that client 102. The banner ads may also track redirection. That is, when a client 102 selects a banner ad, the link and the banner ad may be captured and stored in a database. The site may provide a user profile update tool by which the client 102 may make alterations to a user profile.

As will be appreciated, an internetwork including a variety of Web sites, databases, and servers as described may include vast amounts of unstructured data available to a researcher. Systems and methods for harnessing this data will now be discussed in more detail.

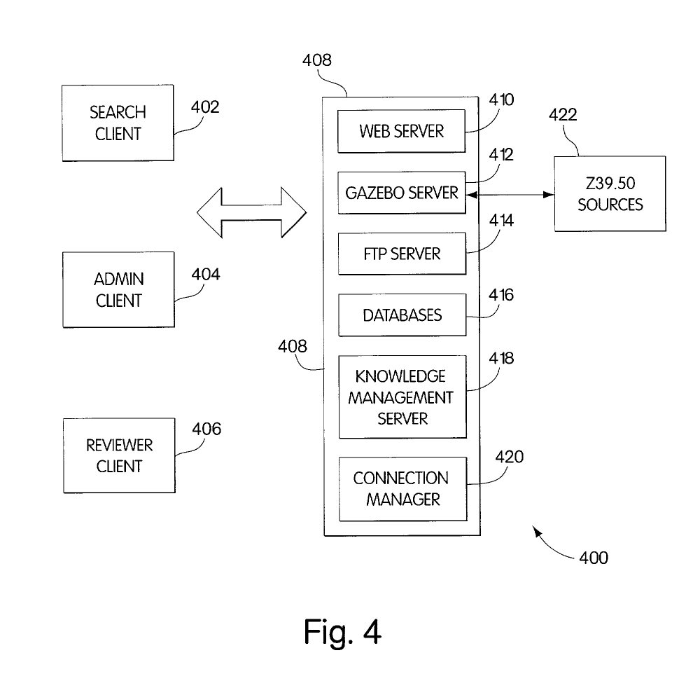

FIG. 4 shows an architecture that may be used with the systems described herein. The research system 400 may be deployed as a collaborative research system that permits review and modification of queries and search results by different entities, with access privileges, and levels thereof, controlled and changed throughout iterative stages of a research project. The research system 400 may include one or more search clients 402, one or more administrative clients 404, one or more reviewer clients 406 and a system 408 that includes a web server 410, a Gazebo server 412, an FTP server 414, one or more databases 416, a knowledge management server 418, and a connection manager 420. The Gazebo server 412 may communicate with one or more Z39.50 sources 422, which provide access to data sources according to a predetermined protocol. It will be appreciated that, while a particular architecture is disclosed in FIG. 4, other architectures may be used with the systems described herein. Furthermore, components of the research system 400, such as within the system 408, may be deployed on a single physical device or distributed on a local network or across an internetwork.

The search client 402, the administrative client 404, and the reviewer client 406 may communicate with the system 408 through a network. The search client 402 may be any software and/or hardware client operating on a client device, including a browser along with any suitable plug-ins, a Java applet, a Java application, a C or C++ application, or any other application or group of applications operating on a client device. The administrative client 404 may generally provide administrative control over the system, including account management, creation of new users, modification of existing users, and so forth. Administrative functions may also include control over access restrictions to collaborative research projects, referred to herein as “shoeboxes”. The reviewer client 406 may be a simple Web browser, or other client, for viewing shoeboxes maintained by the system 408. Each of the clients may include a variety of renderers for viewing data from different sources including word processing applications (e.g., Word or WordPerfect), spread sheet applications (e.g., Excel or Lotus), presentation applications (e.g., Microsoft PowerPoint), or other generic data formats such as PDF, GIF, PNG, and so forth. It will be appreciated that more than one of each type of client may access the system 408 at one time.

The Web server 410 may provide Web access to the research system 400, by the search client 402, the administrative client 404, and/or the reviewer client 406, where one or more of those clients are deployed using the HTTP protocol. The Web server 410 may also provide a front-end for new or prospective users of the research system 400, where these users may find information about the system, download supporting software, such as a search client 402, register as a user, and so forth. It will be appreciated that the Web server 410 may include a plurality of logical and/or physical servers, as appropriate to the level of traffic supported by the research system 400.

The Gazebo server 412 supports connections to Z39.50 data sources 422. This server provides access to data sources using Z39.50 services (which defines a protocol and query structures), such as Medline, Cancerlit, LOC, and other public databases. Other servers, clients, or combinations of these may be included in the system 408 where other data sources are to be searched by the system 408 using known protocols, including peer-to-peer protocols such as Gnutella.

The FTP server 414 may provide data to remote requesters, including, for example, search client software, upgrades, and data archived by the system 408.

The databases 416, which may be a single physical database, may include several discrete categories of data, each organized as a separate database. For example, one database may be a user information database. This database may store information relating to registered users of the system 400, including access privileges, authentication and security data, usage history, interests or “shoeboxes” maintained by each user, version information for client software, and so forth. Another database may be a research database. This database may store interests and search results for each interest. This may include Web addresses for responsive documents, or the full text and images of documents found at those Web addresses. Another database may be a vocabulary database. This database may store one or more lexicons locally, and may provide information concerning remote lexicons available to the system 408. Lexicons may include definitions of specialized vocabularies for medicine, chemistry, engineering, and so forth, along with antonyms, synonyms, and other information. As will be described in more detail below, these lexicons may be used to modify and refine queries used to build interests.

The knowledge management server 418 may provide core services for the knowledge management system 400, including refinement of interests and searches, execution of searches, and organization and presentation of search results. Refinement of interests, for example, may include determining suitable lexicons for a particular area of interest, and applying one or more selected lexicons to a search to generate an enhanced Boolean query. Executing searches, for example, may include presenting queries to a number of Web search engines, public or private databases available through the network, a search engine for local data and files, databases provided through dynamic Web site front-ends (deep web searches), and so forth. Organization and presentation of search results, for example, may include maintaining hierarchical relationships among documents and controlling access privileges to documents stored in an interest. Each of these functions will be described in further detail below. The knowledge management server may also control presentation of user interfaces to the search client 402, the administrative client 404, and the reviewer client 406, or these user interfaces may be controlled by the Web server 410 or other components of the system 408.

The connection manager 420 controls connections to the system 408. This may include connections to the Web server 410, the Gazebo server 412, the FTP server 414, and the knowledge management server 418. The connection manager 420 may permit concurrent use of one or more of the servers by a number of clients, and may monitor and control access through various authentication and access techniques.

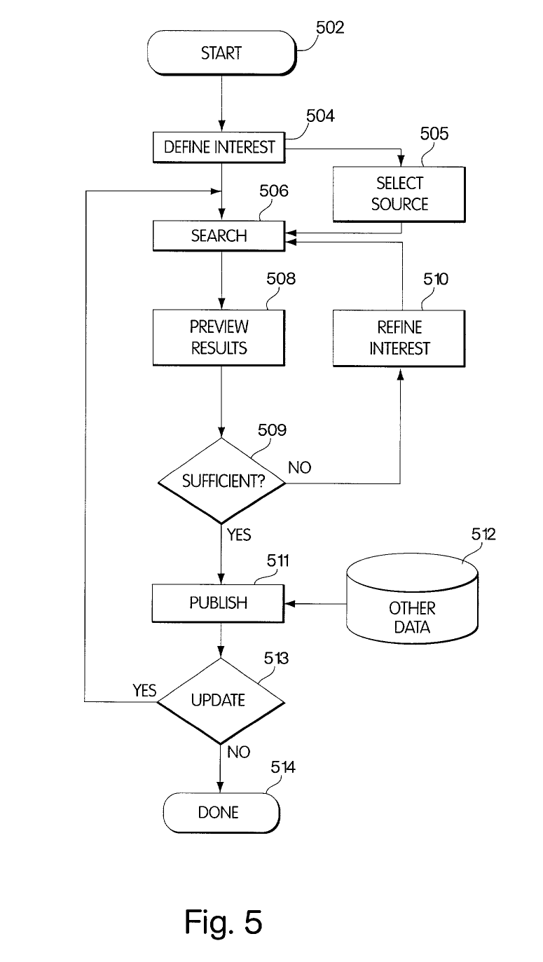

FIG. 5 is a flow chart of a search process using the systems described herein. The process 500 may begin 502 when an interest is defined, as shown in step 504. This interest may be a general interest specified by a user through, for example, the search client 402 of FIG. 4. The user may provide any vocabulary limiting or qualifying the interest. Each interest is persistent, and the knowledge management system may remember all active interests of a particular user. The user may control strength filters for each of one or more terms in the interest so that search results may be weighted in favor of one or more predetermined words.

The interest may be further refined using lexicons provided by academic institutions, professional organizations, or the like. Known lexicons accessible through the Internet include, for example, UMLS, Metaphrase, SciTech, and WordNet. Terms within a user-specified interest may be compared to one or more of these lexicons, or other lexicons maintained by, or accessible to, the system 408 of FIG. 4, with definitions or portions thereof being including within a Boolean search query derived from the interest. The resulting query may also, or instead, be supplemented with synonyms and antonyms provided by the lexicons. Antonyms may be provided as additional search terms, or may be used to identify documents that should be excluded from the search results, or de-weighted relative to other search results.

It will be appreciated by one of ordinary skill in the art that search terms may include wildcards or any other symbols or instructions to indicate, for example, that plural or other variant forms should or should not be included as responsive to a particular search, or whether capitalization should affect search results, or whether exact word or phrase matches are required, and so forth. Similarly, a numeric wildcard may be provided that matches on any number, but not on any alphabetic character. Wildcards may also be of specified length (e.g., exactly three alphanumeric characters) or of unspecified length (e.g., any number of alphanumeric characters). A terminator symbol may be included that matches to any number and type of characters at the end of a word, as may be usefully employed to find any words matching a particular word root or stem.

The application of lexicons to interests may be automatic, semi-automatic, or manual. In an automatic application of one or more lexicons, synonyms and definitional text may be added to Boolean search query. In a manual application, contents of the lexicon may be displayed to a user so that the user may select suitable verbiage from the lexicon to enhance the search. In a semi-automatic application, contents of one or more lexicons may be added to the query, and a user may weight portions of lexical verbiage for purposes of scoring responsive search results.

Once an interest has been defined, a one or more sources may be selected, as shown in step 505. The search may be performed across a number of data sources. The sources to be searched may be user-specified, as shown in step 505, or may be determined automatically by the system 408 of FIG. 4. Where user-specified sources are to be searched, a menu of available resources may be provided within a user interface, from among which a user may explicitly specify sources. Available sources may be further categorized by topics, institutions (private, private fee-based, public, government, academic, etc.), and so forth, so that a user may broadly specify types of resources within identifying individual sources to be searched. This feature may be particularly useful where a large number of resources are accessible by the system. A user may also manually enter one or more sources, such as directory path information, database names and/or locations, and so forth, along with types of data to be searched for and any other relevant information.

Once sources have been selected, either by the user as in step 505, or automatically, a search may be performed, as shown in step 506. One type of search is a search of local databases and/or file systems, such as within a local area network, corporate area network, or wide area network shared by the knowledge management system. The local search may include searches of applications and application-created documents, such as electronic organizers, spreadsheets, and so forth.

Another type of search is a conventional Internet search using, for example, search engines such as AltaVista, Google, and the like. Meta-search engines may instead, or in addition, be used to perform searches of documents indexed by a number of different search engines.

Another type of search is a search of electronic databases that are available on a login basis. These may be publicly available databases such as those maintained by the U.S. Patent Office or the Securities Exchange Commission, as well as those maintained by private organizations, such as IBM's searchable library of technical documents. Academic and professional institutions also maintain a wide variety of publicly available, searchable databases that may be applicable to various topics of interest. The databases may also be privately operated commercial databases, such as Lexis/Nexis, WestLaw, and Dialog, that charge fees on a per-minute or per-search basis. These may also be privately operated databases that provide unlimited access for a fee, such as those maintained by periodicals, newspapers, and professional organizations.

Another type of search is a so-called deep Web search. This type of search may be used to extract back-end data from a dynamic Web front-end by presenting search instructions to the front-end at a Web site. Searching may also be performed throughout other publicly available networks such as Usenet and Gopher, as well as peer-to-peer networks such as those using Gnutella or Napster. More generally, any resource available through the internetwork that is capable of responding to structured search queries or instructions may be included within a search as described herein.

Search results may be stored within the system 408 of FIG. 4 in their entirety, or in part, as where extracts responsive to the query or locally stored, along with a reference to the source data location. Optionally, the local system may only store location information.

Once search results have been obtained, the process 500 may proceed to step 508 where results are previewed. It will be noted that the systems described herein provide for a single user interface for multiple information sources, including desktop data, enterprise data, private databases, electronic libraries, and the Internet. Thus a search may be integrated across disparate data sources from commercial databases, enterprise-wide document management systems, and public networks, to a user's local hard drive or e-mail records.

A search result may be presented by title and hierarchically organized by data source, e.g., Internet, private database sources, local data, and so forth. The search results may be further sorted by relevancy using any suitable scoring system. For example, as noted above, various components of a query may be weighted by a user, with the user-provided weightings used to calculate relevancy rankings for search hits. A threshold may also be provided below which search results will not be presented to a user. A user may review the titles in a search result, and perform certain functions on titles. A user may review a title by selecting the title in the user interface. The document corresponding to the title may then be presented within the user interface, and the user may delete, save, or ignore for now, each document. The user may elect to save local copies of one or more titles and related documents. Thus a user may manually sort through research results, and store desired documents in a structured manner.

The user may also add a title to a skip list of URL's, or other data sources, paths, etc., from which the user does not wish to see further data in searches, either for a specific interest or for all interests.

A search result may be further automatically analyzed by the system. This analysis may include finding terms responsive to a search query within a document, and building an index of hyperlinks to those paragraphs (or other areas) within the document. The index may be presented within an area of the user interface, so that a user may quickly locate topical text within a document retrieved by the system.

The document may be stored in its analyzed, hyperlinked form, along with other search results, within a shoebox of documents related to an interest. A shoebox may be structured hierarchically, with folders and sub-folders added by the user. In this manner, a user may create any desired hierarchical structure for search results relating to an interest. Additional local information may be added to the shoebox as annotations or other documents. This may include user information, such as an electronic organizer entry of contact information, as well as word processor document annotations, or any other locally generated data of interest.

Once a search for an interest has been reviewed and organized into a shoebox, the user may determine whether the results are sufficient, as shown in step 509. If the results are not sufficient, then the user may refine the interest as shown in step 510. This may include, for example, removing search terms, adding search terms (such as disjunctive alternative words for a concept), replacing search terms, and so forth.

If search results are determined to be sufficient in step 509, the process may proceed to step 511 where the results may be published. Publication may be controlled in a number of different manners. This may include limiting read privileges to the shoebox, or to one or more folders within a shoebox, to certain authorized users. Write privileges may also be provided to one or more authorized users, so that a number of users may edit, supplement, or re-structure the shoebox, and provide annotations for documents within the shoebox. At any time, such as after results have been reviewed and edited by a number of users of a period of time, the entire contents of the shoebox may be opened to the general public, such as by publishing the results on the Internet. Or the shoebox may be provided in its final form to a more limited audience, such as users on a corporate area or local area network, or a group of predetermined users. Access control may be defined along, for example, individual, group, enterprise, and public categories.

In one embodiment, publication may be in a Web-based format. For example, each item within the shoebox may be parsed to locate text or other data responsive to an interest. The interest may then be hyperlinked to responsive subject matter within shoebox items. This may be performed by the system without user interaction. The text of the interest may then be presented within a browser, and responsive subject matter within shoebox items may be accessed through hyperlinks from the text of the interest. The interest may be further parsed so that each aspect (e.g., each word) of the interest has associated therewith a collection of responsive locations within items of the shoebox, so that a user may browse directly to text of interest within each document. These links may be manually edited, and new links added, to supplement the automated linking of the interest and the shoebox items described above.

Other data 512 may be added to the shoebox for publication. This may include any data specifically identified by the user, and may include local data, remote data, links to data including objects of any form, and so forth.

Before or after general publication, search results may be updated as shown in step 513. Supplemental searching may be performed at targeted locations. For example, if a user locates a Web site with substantial information relating to an interest, the user may perform a search only within that Web site, and supplement existing results with the results from the targeted site. Also, periodic updates may be automatically performed so that documents within an interest, or within a shoebox based upon an interest, may be kept up to date. Where updates are to be performed, the system may return to step 506 where additional searches are performed. In addition, individuals or groups using a shoebox may receive notification, such as by electronic mail, wireless messaging, or online instant messaging, that a search for the shoebox has been updated.

Where no additional searches are to be performed, the system may finish, as shown in step 514. The shoebox may be maintained for public or private access, or may be deleted or otherwise maintained.

It will be appreciated that the above process 500, may be realized in hardware, software, or some combination of these. The process 500 may be realized in one or more microprocessors, microcontrollers, embedded microcontrollers, programmable digital signal processors or other programmable device, along with internal and/or external memory such as read-only memory, programmable read-only memory, electronically erasable programmable read-only memory, random access memory, dynamic random access memory, double data rate random access memory, Rambus direct random access memory, flash memory, or any other volatile or non-volatile memory for storing program instructions, program data, and program output or other intermediate or final results. The process 500 may also, or instead, be realized in an application specific integrated circuit, a programmable gate array, programmable array logic, or any other device or combination of devices that may be configured to process electronic signals.

Any combination of the above circuits and components, whether packaged discretely, as a chip, as a chipset, or as a die, may be suitably adapted to use with the systems described herein. It will further be appreciated that the above process 500 may be realized as computer executable code created using a structured programming language such as C, an object-oriented programming language such as C++ or Java, or any other high-level or low-level programming language that may be compiled or interpreted to run on one of the above devices, as well as heterogeneous combinations of processors, processor architectures, or combinations of different hardware and software. The process 500 may be deployed using software technologies or development environments including a mix of software languages, such as Microsoft IIS, Active Server Pages, Java, C++, Oracle databases, SQL, and so forth.

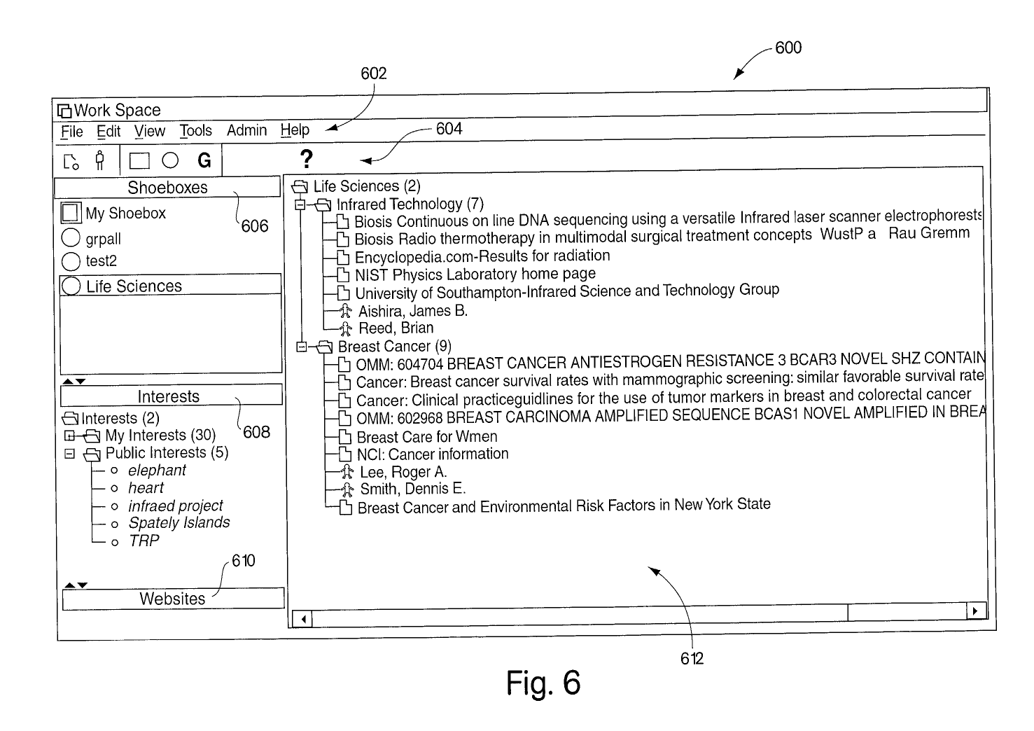

FIG. 6 depicts a user interface that may be used with the systems described herein. As described above, the interface 600 may be deployed as an application running on a local machine, as a remote service run from an application service provider, as a Web-based resource accessible over an internetwork, or any other mode suitable for use at a client device. Functionality may be distributed in any suitable manner between the client device and one or more remote resources such as databases, servers, and the like. It will be appreciated that the interface 600 depicted in FIG. 6 is an example, and that other arrangements of the interface may be used consistent with the systems described herein. It will also be appreciated that menus, submenus, and other interface screens may be usefully employed to support the functionality of the interface, such as menus for controlling search terms, scoring, relevancy of search results, filters for returning results, and so forth.

The interface 600 may include, for example, a menu bar 602 of drop down menus, a menu bar 604 of buttons providing various functions, one or more shoeboxes displayed in a shoebox area 606, one or more interests displayed in an interest area 608, one or more Web sites displayed in a Websites area 610, and a workspace 612. The menu bars may provide functions and utilities associated with the system. Including interfaces for controlling interest definitions, scoring, ranking, filters, and so forth.

The shoebox area 606 may display shoeboxes prepared by the user, or for which the user has editing/authorship access. When a shoebox is selected within the shoebox area 606 of the interface 600, the contents of the shoebox may be displayed in the workspace 612. As shown in FIG. 6, the contents may be hierarchically organized, and may include one or more folders, Website references, biographical and/or contact information for people, and so forth. Using the interface 600, objects and data may be manually added to, or removed from, a shoebox or shoebox folder. This may be performed, for example, using drag-and-drop manipulations within a Windows environment or any other graphical-user-interface-based operating system or environment. A shoebox may be used, for example, to store unstructured data having a common use, such as information about people (name, address, contact information, etc.), tasks (time, location, etc.), presentation materials, and so forth that relate to a particular project. In this sense, a shoebox may be used as a database or file system of topical information.

The interests area 608 may display interests available to the user. The interests may be organized hierarchically, and may include private interests of the user, as well as public or semi-public interests available to the user. Although not shown in FIG. 6, it will be appreciated that when an interest is selected, information related to that interest may be displayed in the workspace 612. This may include properties of an interest such as search queries, relevant databases, and so forth.

It will be appreciated that the above systems and methods provide an integrated research environment that permits seamless access between public networks, private data, and a user's own desktop. This platform may be usefully applied to many different research environments where multiple users have varying degrees of access to data.

An interest and shoeboxes may be built around an investment portfolio run by, for example, an investment club or managed by a group of managers at disparate locations. The shoeboxes may be used to organize and maintain information about companies within the portfolio, and may include, as examples, historical price and performance data for companies, other historical data that may relate to stock price, research reports created by professional stock analysts, excerpts from topical list servers or chat rooms, product information for company products, market analysis, news clippings, and any other data which may relate to stocks and stock prices. Further, shoeboxes or folders within shoeboxes may be created for stocks which are not yet owned, but may be under consideration for purchase, so that users may gather and share information prior to a purchasing decision, and annotate any search results within the shoebox.

An interest may be built around a research project. For example, a doctoral candidate researching a particular subject may build a shoebox for that subject, and may selectively publish lab results, draft papers, slides presented at conferences, and any other research materials. The shoebox may be open to other students at the researchers academic institution, or to other doctoral candidates or academics around the world working on similar subject matter. More generally, data may be gathered from a wide range of sources in industry, government, and academia, and published in structured form for use by peers within the research community.

Another possible academic application may be education. An interest and a shoebox may be built around a curriculum for a class, with homework assignment, problem sets and solutions, reading materials, and so forth gathered by an instructor and organized within a shoebox into class materials. In this environment, groups of students may collaborate on certain projects, and have shared access to one or more sub-folders within a shoebox for this purpose.

As another example, a shoebox may be used for complex legal subject matter such as complex litigation. For example, a mass-tort or shareholder class-action lawsuit may require varying levels of information among different parties. Different attorneys may represent different members of a class, and may cooperate as a steering committee for a litigation. Potential plaintiffs may opt into or out of the class, and may be entitled to different information as potential plaintiffs, class members, or non-class members. In this context, confidential information may be shared in a restricted manner, while certain information such as deposition transcripts and discovery, may be shared among all parties to the lawsuit. Similarly status information concerning progress of the action may be disseminated to appropriate parties, and press releases may be publicly disseminated. The shoebox may also serve as a vehicle for more general investigation by providing a description of the action and descriptions of needed information for general, public review.

As another example, the systems described herein may be used by local government or particular governmental agencies to gather, share, and publish information. So, for example, a town may publish ordinances, minutes from town meetings, schedules for town-sponsored events, and any other items of public interest. The town may gather research relating to various topics, and publish results in any suitable manner. Contributions may also be permitted to the site in any manner from moderated forums to un-moderated public bulletin boards.

It will thus be appreciated that many combinations of the above systems may be used in research applications as described herein. For example, the system may be used for academic research, industry research, or government research in applications such as finance, investment, education, biotechnology research, oil and petroleum prospecting, service industries, academic research, legal research, and so forth.

It will further be appreciated that a number of different architectures may be based upon the system described herein. For example, the research client described herein may be licensed for remote use through a Web browser plug-in, remote use through an application service provider, or remote use through a proprietary local client. The software and/or hardware system may, instead, be sold or licensed for use as a research tool on a local or corporate area network.

Thus, while the invention has been disclosed in connection with the preferred embodiments shown and described in detail, various modifications and improvements thereon will become readily apparent to those skilled in the art. It should be understood that all matter contained in the above description or shown in the accompanying drawings shall be interpreted as illustrative, and not in a limiting sense, and that the following claims should be interpreted in the broadest sense allowable by law.

What is claimed is:

1. A method comprising:
providing an interest that includes a textual description of a topic;
refining the interest using one or more lexicons that provide other words to combine with the textual description to form a search query;
searching a plurality of resources available through a network based upon the search query to obtain search results that are responsive to the search query;
organizing the search results into a shoebox that displays the search results for user manipulation; and
publishing the search results in the shoebox with an access level that determines one or more authorized users who may access the search results.

2. The method of claim 1 wherein the textual description comprises alphanumeric characters.

3. The method of claim 1 wherein the textual description comprises at least one of a wildcard that match at least one of any alphanumeric character, a numeric wildcard that matches any numeric character, or a terminator that matches on any character or combination of characters.

4. The method of claim 1 wherein the textual description comprises one or more word stems.

5. The method of claim 1 wherein the access level controls authorization to perform at least one of viewing search results, editing search results, editing the interest, or editing the search query.

6. The method of claim 1 wherein the one or more lexicons comprise at least one of antonyms, synonyms, or definitions for one or more words.

7. The method of claim 1 wherein the one or more lexicons comprise at least one of a Unified Medical Language System lexicon, a Metaphrase lexicon, a SciTech lexicon, a WordNet lexicon, or a PubMed lexicon.

8. The method of claim 1 further comprising selecting the plurality of resources from among a list of resources available through the network.

9. The method of claim 1 wherein the plurality of resources includes at least one of an Internet search engine, a database, a local file system, a distributed file system, a document management system, an electronic library, a commercial database or a public database.

10. The method of claim 1 wherein searching the plurality of resources includes presenting a search query to one or more dynamic Web sites that include their own search engines for searching one or more databases.

11. The method of claim 10 further comprising presenting a formatted query to a URL that presents a front-end for a database.

12. The method of claim 1 wherein publishing the search results further comprises publishing the search results in a Web-accessible form.

13. The method of claim 1 further comprising determining a score for each search result indicative of a relationship between the search result and the search query.

14. The method of claim 13 further comprising at least one of ranking each search result according to the score or filtering each search result according to the score.

15. The method of claim 1 wherein the search query includes one or more Boolean operators.

16. The method of claim 1 further comprising providing a hyperlink to one or more words responsive to the search query within one or more of the search results.

17. The method of claim 1 further comprising updating the search results.

18. The method of claim 17 further comprising updating the search results on a predetermined schedule.

19. The method of claim 1 further comprising adding one or more electronic documents to the search results.

20. The method of claim 1 further comprising revising at least one of the interest or the search query.

21. The method of claim 1 wherein organizing search results further comprises organizing search results according to at least one of source, size, type, date, or score.

22. The method of claim 1 wherein organizing search results further comprises manually selecting items of interest for the shoebox.

23. The method of claim 1 further comprising providing a skip list that specifies one or more documents that should be excluded from the interest, and excluding the one or more documents from new or revised searches relating to the interest.

24. The method of claim 1 wherein the interest comprises at least one of investment, education, academic research, biotechnology, oil & petroleum, service industries, legal services, medicine, biomedicine, engineering, information technology, or system engineering.

25. The method of claim 1 further comprising providing notification of updates to interest through at least one of electronic mail, wireless messaging, instant messaging.

26. The method of claim 1 further comprising associating one or more seminal documents with at least one of the one or more lexicons.

27. The method of claim 1 further comprising annotating one or more of the search results.

28. A method comprising:
receiving a search query that includes one or more search terms;
presenting at least one of the search terms to a lexicon, the lexicon including a plurality of defined terms, each defined term including one or more definitions and at least one of an antonym, a synonym, and a variant for the defined term;
identifying one or more additional search terms from the lexicon corresponding to the at least one of the search terms; and
constructing a revised query that includes the at least one of the search terms in Boolean combination with the one or more additional search terms; and
presenting the revised query to a searchable resource.

29. A method comprising:
performing a structured search of one or more network resources to obtain a search result;
publishing the search result in a network-accessible format, access to the search result being restricted to one or more authorized users;
iteratively refining the search result through at least one of receiving a request from one of the authorized users to exclude a document in the search result, receiving a request from one of the authorized users to include a document not in the search result, and receiving a request from one of the authorized users to modify the structured search;
storing the iteratively refined search result in an unmodifiable form; and
publishing the unmodifiable form of the iteratively refined search result in a network-accessible format, access to the iteratively refined search result being unrestricted.

30. A system comprising:
interest providing means for providing an interest, the interest including a textual description of a topic;
interest refining means for refining the interest using one or more lexicons, the one or more lexicons providing other words to combine with the one or more words of text to form a search query;
searching means for searching a plurality of resources available through a network based upon the search query to obtain search results, each search result being responsive to the search query;
organizing means for organizing the search results into a shoebox that stores the search results; and
publishing means for publishing the search results in the shoebox with an access level that determines one or more authorized users who may view the search results.

31. A system comprising:
a client with which a user provides an interest, the interest including a textual description of a topic, the client configured for the user to refine the interest using one or more lexicons, the one or more lexicons providing other words to combine with the one or more words of text to form a search query;
a network device that uses the search query to search a plurality of resources available through a network to obtain search results, each search result being responsive to the search query;
the client further configured to receive the search results and present the search results to a user, and to receive instructions from the user to organize the search results into a shoebox that stores the search results; and
the network device further configured to publishing the search results in the shoebox with an access level that determines one or more authorized users who may view the search results.

32. A computer program product comprising:
computer executable code for providing an interest, the interest including a textual description of a topic;
computer executable code for refining the interest using one or more lexicons, the one or more lexicons providing other words to combine with the one or more words of text to form a search query;
computer executable code for searching a plurality of resources available through a network based upon the search query to obtain search results, each search result being responsive to the search query;
computer executable code for organizing the search results into a shoebox that stores the search results; and
computer executable code for publishing the search results in the shoebox with an access level that determines one or more authorized users who may view the search results.

33. The computer program product of claim 32 wherein the computer executable code for providing an interest, the computer executable code for refining the interest, and the computer executable code for organizing the search results are provided to a client over a network using an application service provider model.

34. The computer program product of claim 32 wherein the computer executable code for searching a plurality of resources and the computer executable code for publishing the search results are provided as a server on at least one of a local area network or a corporate area network.

35. The computer program product of claim 32 configured as a desktop application for searching, organizing search results, and publishing search results.
